(19) United States
(12) Patent Application Publication
(10) Pub. No.: US 2007/0045307 A1
(43) Pub. Date: Mar. 1, 2007

(54) Radio frequency textile drying machine

(75) Inventors: William Tak Ming Tsui, Hong Kong (HK); Ralph Wai Lam Ip, Hong Kong (HK)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FALMER INVESTMENTS LTD., Tortola (VG)

(21) Appl. No.: 11/268,571

(22) Filed: Nov. 8, 2005

(30) Foreign Application Priority Data
Aug. 8, 2005 (EP) 05254940.9

(51) Int. Cl. H05B 6/60

(52) U.S. Cl. 219/775

(57) ABSTRACT

A textile drying machine comprises a tank for receiving textiles with a spindle inside the tank for supporting the textiles, and a solid-state radio frequency generator. The generator is connected to the spindle and the tank is earthed so that when the generator is operated an oscillating electric field is generated between the spindle and the tank, and hence applied to textiles on the spindle. The electric field heats water molecules in the textiles by molecular vibration so that evaporation occurs, and the water vapor is removed from the tank by an extractor fan. The machine may also be used to dye the textiles prior to drying, thus providing an integrated dyeing/drying machine.

### BACKGROUND OF THE INVENTION

The present invention relates to a machine that uses radio frequency waves for drying textiles.

Radio frequency (RF) energy can be used to dry dielectric materials such as textiles. The principle of using radio waves for drying is to apply an electric field oscillating at a radio frequency to the material. This excites molecular vibration at the oscillation frequency in the molecules of the material, which gives an internal heat gain by means of inter-molecular friction. If the material is wet, the heat gain causes the water molecules in the material to undergo a phase change from liquid to gas when enough energy has been absorbed. The gas phase water molecules are then free to escape from the material by evaporation so that the material becomes dry. The amount of heat required to evaporate a unit weight of water is a fixed quantity at a constant pressure. The total amount of heat required to raise the water from a given temperature to evaporating point depends on the total mass of the water. A commonly used radio frequency for drying in the textile industry is 27 MHz.

Typical RF textile dryers consist of a conveyor belt that transports yarn packages into and out of a safety cabinet (gallery). A set of parallel electrodes is installed inside the gallery, and a RF electric field is applied between the electrodes using a RF wave generator. The yarn packages are conveyed through the electric field so that water molecules trapped in the yarn undergo dipolar vibration, gain of internal thermal energy and subsequent evaporation. The evaporated moisture is then carried away by an extraction fan mounted above the electrodes. An example of such a dryer is given in EP 0,651,590.

Commonly, a coaxial cable is used to transmit the generate RF wave from the generator to the anode electrodes, while the cathode electrodes are connected to earth for grounding. The anodes may take the form of a rectangular element such as aluminium bars. The generator typically comprises an oscillator and a triode, and may be referred to as an electron tube. The triode has three poles, namely an anode, a cathode and a grid. The oscillator generates a signal at the desired frequency which is applied to the grid, and a high voltage between the anode and cathode amplifies the oscillating power to provide a high power RF wave to be transmitted to the anodes of the dryer. The typical lifetime of an electron tube is about 2000 hours. When used in a textile dryer, such tubes need to be replaced every 3 to 6 months to compensate for deteriorating operation. The generator will require a cooling system. Air cooling is commonly used, but water cooling is more effective in prolonging the tube life span.

A disadvantage of using electron tubes for RF drying is that they are prone to cause a relatively high level of electromagnetic interference in telecommunication devices. This has many undesirable effects, such as jeopardizing air flight communication. The interference is caused by leakage of the RF wave from openings in the gallery through which the conveyor belt passes.

Additionally, there are difficulties in controlling the operating frequency of electron tubes. For a fixed working frequency of 27 MHz, a power regulator is needed to compensate for any variation in the separation between the dryer electrodes. Good power regulation, such as from a variable capacity coupling circuit, is difficult to achieve, so fixed electrode designs are rarely used except for special applications.

Hence, there is a requirement for an improved RF textile dryer.

### SUMMARY OF THE INVENTION

Accordingly, a first aspect of the present invention is directed to apparatus for drying textiles comprising: a tank for receiving textiles, the tank defined by a first tank portion and second tank portion that are electrically insulated from one another; and a radio frequency power generator connected to the tank so as to be operable to generate an oscillating electric field at a radio frequency between the first tank portion and the second tank portion, to produce heating and evaporation of water molecules in the textiles.

The invention provides a radio frequency textile drying machine in which those parts of the machine that form the textile receptacle (tank) are also used as the anode and cathode for applying the electric field to the textiles to cause drying. This arrangement provides a compact drying machine, and also permits superior electromagnetic shielding to reduce interference and improve safety because the field can be wholly contained within the tank.

The first tank portion may comprise a wall of the tank, and the second tank portion may comprise a spindle positioned within the tank for supporting textiles received in the tank. Machines comprising tanks and spindles are already commonly used for various textile processing applications, in particular textile dyeing, so machines according to the present invention can be readily provided using modifications to existing designs. Also, a tank and spindle arrangement for the machine has been found to offer uniform textile drying capabilities without the need for precise adjustment of the anode-cathode separation, as compared to conveyor-type radio frequencies driers.

In one embodiment, the radio frequency power generator is connected to the spindle such that the spindle acts as an anode for the purpose of generating the electric field. Consequently, the wall of the tank therefore acts as the cathode. Preferably, the wall is connected to electrical ground. This gives good electromagnetic shielding without the need for dedicated shields to be provided around the machine.

The radio frequency power generator may be a solid-state radio frequency power generator. Solid-state radio frequency generators have much greater operating lifetimes than conventional electron tube generators, so maintenance costs are reduced. Efficiency is also better.

According to one embodiment, the radio frequency power generator comprises a driver unit operable to generate a radio frequency signal and one or more amplifier units operable to receive the radio frequency signal from the driver unit and amplify the radio frequency signal. This modular design allows for improved and simplified maintenance, since the units can be serviced and replaced individually. Such a design also gives the high power necessary for textile drying in a convenient format that avoids or reduces many heat generation problems. Air cooling is sufficient; this is preferable to water cooling.

The radio frequency power generator may further comprise a divider unit operable to receive the radio frequency signal from the driver unit and distribute it between at least two amplifier units arranged in parallel, and a combiner unit operable to receive and combine the amplified radio frequency signals from the amplifier units. Parallel amplification allows a high radio frequency power to be generated directly in a single amplification step. Also, operation of the generator and hence the drying apparatus can continue in the event of failure of one or more amplifier units, and also during replacement of a failed unit. Operating costs are thereby enhanced since machine down-time is reduced.

Furthermore, one or more of the driver unit and the amplifier units can be provided with built-in test devices operable to monitor operation of the units. This is a further advantage of a modular solid-state configuration. The various units or modules can be monitored on an individual and continuous basis so that any problems are identified rapidly and maintenance can be carried out efficiently.

The tank may be provided with an outlet for extraction of evaporated water molecules. This improves the drying process since the textiles do not remain in a humid atmosphere, and the water molecules can more readily escape from the textiles. Also, the tank maybe further provided with an inlet for introduction of air into the tank. If fresh air is added to the tank as the water vapour-laden air is removed, the pressure in the tank is kept roughly constant, and air circulation is improved, further enhancing the drying process.

In an advantageous embodiment, the apparatus is further configured for dyeing of textiles received in the tank. This is made particularly possible by performing radio frequency drying using an anode and a cathode that form a tank within which the textiles are held, since a tank arrangement is suitable for use in other textile processing applications, such as dyeing. Existing tank designs such as package dyeing tanks can be readily adapted to embody the present invention and hence provide integrated dyeing and drying machines. New designs of machine are also possible, where the portions that define the tank can be optimised for both the dyeing and drying processes. For example, the tank may be provided with an dye liquor inlet and a dye liquor outlet by which dye liquor may be circulated through the tank to dye textiles received in the tank.

Although the present invention is applicable to a wide range of textiles, and also to other materials that can tolerate radio frequency drying and be readily accommodated within a tank. In a particular example the apparatus is configured for the drying of dyed yarn. Hence, the textiles may comprise one or more yarn packages.

A second aspect of the present invention is directed to a method of drying textiles, comprising arranging textiles within a tank defined by a first tank portion and a second tank portion electrically insulated from the first tank portion; and generating an oscillating electric field at a radio frequency between the first tank portion and the second portion to heat and evaporate water molecules in the textiles.

Other embodiments and examples are set out in the appended claims.

### BRIEF DESCRIPTION OF THE DRAWINGS

For a better understanding of the invention and to show how the same may be carried into effect reference is now made by way of example to the accompanying drawings in which:

FIG. 1 shows a schematic representation of a solid-state radio frequency wave generator for use in an embodiment of the present invention;

FIG. 2 shows a schematic representation of an embodiment of a source driver unit that may be included in the generator of FIG. 1;

FIG. 3 shows a schematic representation of an embodiment of an amplifier unit that may be included in the generator of FIG. 1;

FIG. 4 shows a sectional perspective view of a textile drying machine according to an embodiment of the present invention; and

FIG. 5 shows a close-up sectional perspective view of a lower part of the textile drying machine of FIG. 4.

### DETAILED DESCRIPTION

The present invention proposes a new design of apparatus or machine for drying textiles using high power radio frequency electric fields. The drying capability offered by machines according to the invention allows compact and safe machines to be provided. Moreover, the design of the machine is such that textile dyeing and drying can be carried out in a single machine.

After textiles are dyed (or otherwise wetted in alternative processing techniques) they need to be dried. Radio frequency (RF) power is commonly used to drying, but textile drying using RF frequencies requires high powers. These maybe obtained using electron tubes to generate the RF wave, but electron tubes, and the designs of proposed drying machines proposed that use them, have disadvantages. An alternative to the electron tube is solid-state technology. This is commonly used to generate RF waves for telecommunications applications, such as mobile telephones and wireless networks. However, these operate at low power only. To obtain the high power required for textile drying, the present invention proposes a generator comprising solid-state power transistors, which aims to avoid problems of heat dissipation and hot spots that may arise if a large number of emitters arranged in an array is used to produce the required power levels.

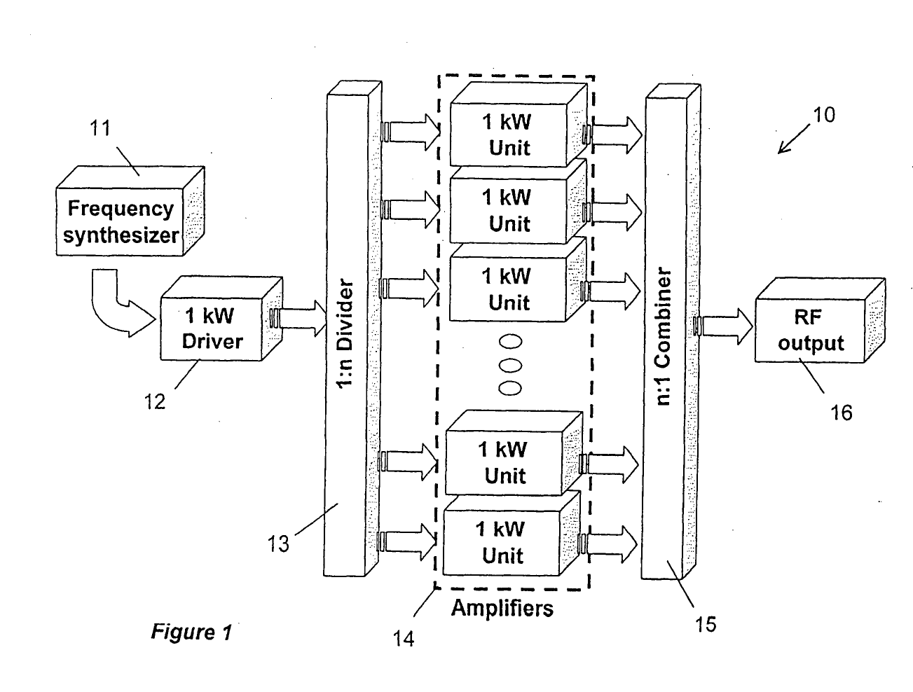

FIG. 1 shows a schematic representation of a solid-state RF generator suitable for use with a textile drying machine according to embodiments of the present invention. The generator 10, which comprises a range of solid-state units, operates to produce an electric field oscillation at a pre-determined radio frequency. To comply with international rules on radio frequencies, the frequency would normally be chosen to be 27.12 MHz for textile drying. The generator 10 comprises a frequency synthesiser 11 which is operable to generate a signal at the desired radio frequency. The synthesised frequency signal is supplied to a source driver unit 12, where it is used to generate the RF wave power. The power passes to a 1:n divider 13, which distributes the power equally between a plurality of amplifier units 14. Each amplifier unit 14 amplifies its portion of the RF wave power, and passes the amplified power to a n:1 combiner 15, which combines the outputs of all the amplifiers 14 to form a single high power RF wave output 16. The source driver unit 12 and the amplifier units 14 may be, for example, 1 kW units, although other size units may be used as required. For a given size of amplifier unit, the quantity n of amplifier units 14 will be selected according to the required power of the output 16. Hence one or more amplifiers can be included as appropriate. A configuration using just one amplifier may omit the divider and combiner. Also, the parallel arrangement of amplifiers is advantageous, but may be replaced by amplifiers in series.

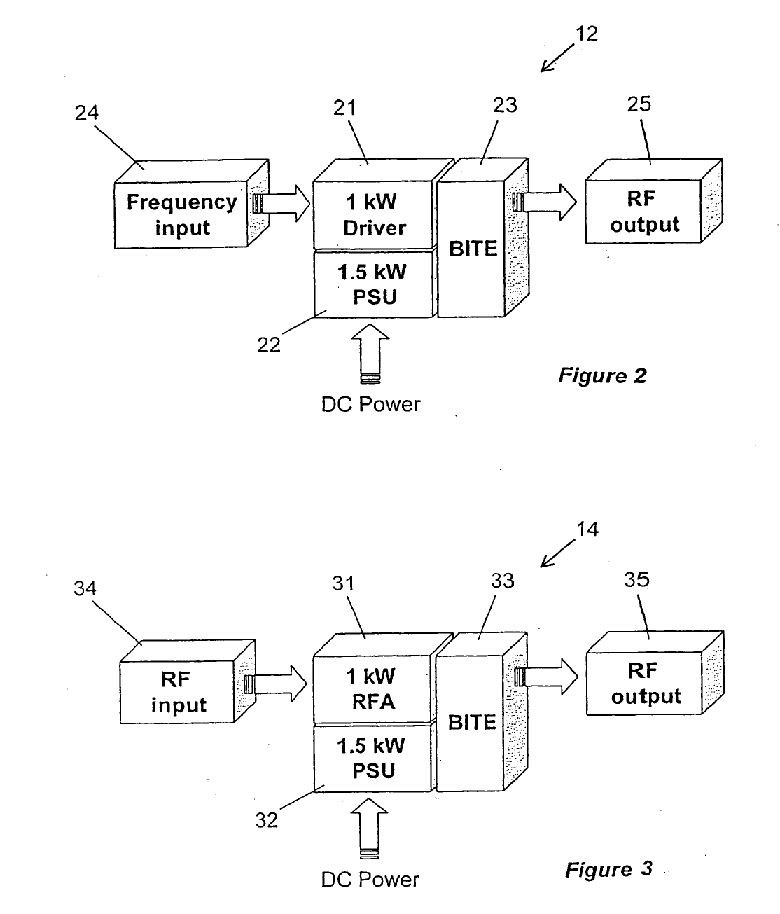

FIG. 2 shows a schematic representation of an embodiment of the source driver unit 12. The driver unit 12 comprises a driver 21 (in this example, a 1K driver) that is powered by an electrical power supply unit 22 that provides DC power (in this example a 1.5 kW power supply). The driver receives a frequency input 24 from the frequency synthesiser 11 of the generator 10, and outputs a RF wave power output 25. Thus, the source driver unit 12 converts a frequency input 24 to an RF power output 25. The source driver unit 12 also includes a built-in testing equipment (BITE) unit 23 to monitor operation of the source drive unit 12. BITE units are devices that are permanently mounted within a larger system and used to test all or part of the system either independently or in association with external test equipment. Many types of BITE unit are available, ranging from simple devices such as a set of meters or switches to complex devices such as computer-controlled diagnostic systems.

FIG. 3 shows a schematic representation of an embodiment of an amplifier unit 14. The amplifier unit 14 comprises a radio frequency amplifier 31 (in this example a 1 kW amplifier), which is powered by a electrical power supply unit 32 that provides DC power (in this example a 1.5 kW power supply). The amplifier 31 receives as an input a RF wave 34 from the l:n divider 13 and amplifies it to output an amplified RF wave 35 to the n:1 combiner 15. The amplifier unit 14 also includes a BITE unit 33 to monitor its operation.

The RF generator of FIG. 1 is a modular design which provides a high degree of flexibility in power generation and maintenance work. The amplifier units are arranged in parallel, so that in the event of failure of any of the amplifier units, the generator can continue to operate, albeit at a reduced power level. Maintenance and replacement of individual amplifier units can be carried out independently without interrupting operation of the other units, so that the generator need not be shut down. Moreover, a modular design gives a better heat distribution across the system, so that air cooling of the generator will produce acceptable cooling results. Air cooling is preferable to the more complex and dangerous (in an electrical environment) water cooling. However, water cooling, or other cooling methods, may be used with the present invention if desired.

To facilitate modular operation, the driver units and amplifier units may be embedded with BITE units (as shown in FIGS. 2 and 3) that allow individual self-monitoring and operation of the driver and amplifier units. Failure of a particular unit can thereby be simply and quickly identified so that the necessary maintenance can be carried out.

Use of solid-state technology to implement the RF generator offers several advantages over electron tube RF generation. Significantly, the lifetime of a solid-state generator can be up to several thousand times that of an electron tube generator, so maintenance costs are vastly reduced. Maintenance is also facilitated using the modular solid-state configuration described above. Furthermore, solid-state generators have better efficiency than electron tubes so that operating costs are also reduced.

The RF generator of FIG. 1, or an alternative RF generator, is employed to apply a high power oscillating electric field to textiles to provide drying by heating and evaporation of water molecules. According to the invention, the electric field is applied by using as electrodes components of that part of a drying machine intended for holding textiles, rather than by way of dedicated electrodes. In particular, a spindle that supports the textiles during the drying process is connected to the RF generator and hence acts as the anode, and a tank for receiving the textiles and in which the spindle is situated acts at the cathode. Preferably, therefore, the tank is connected to earth. The spindle is electrically isolated from the tank. Application of the RF wave from the generator to the spindle provides an oscillating electric field between the spindle and the surrounding tank. Textiles held on the spindle are therefore positioned within the electric field, and subjected to drying.

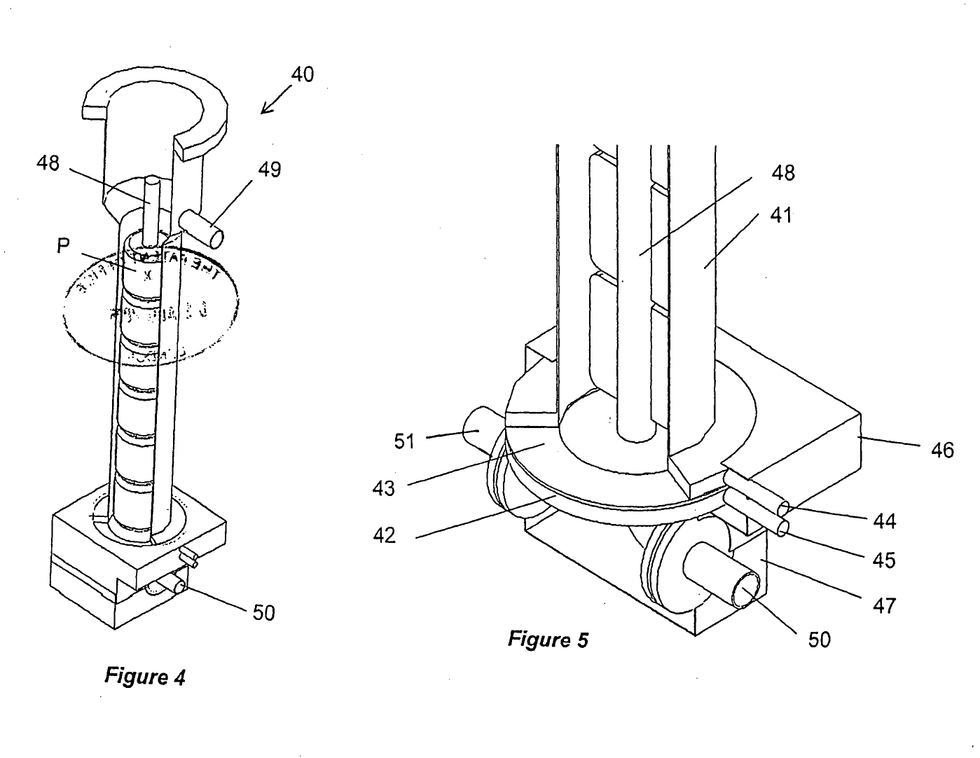

FIG. 4 shows a partially cut-away view of a drying machine 40, and FIG. 5 shows a close-up view of the lower part of the machine 40. Referring to these Figures, the machine 40 comprises a first tank portion or upper part 41 having the form of a vertical cylinder; this forms the side wall of the tank. A base part 42 of the machine 40 closes the lower end of the tank, and is separated from the upper part 41 by a layer of electrically insulating material 43. Any suitable materials that provide the necessary function can be used for the upper part 41 and the base part 42, such as steel, preferably stainless steel, and similarly for the insulating layer 43, which may be Teflon (RTM), for example. A vertical spindle 48 (similarly of steel or stainless steel, for example) extends upwards from the base part 42 along the central longitudinal axis of the tank. The spindle 48 is electrically connected to the base part 42, possibly by being directly fixed thereto or formed integrally therewith. The spindle 48 and the base part 42 together comprise a second tank portion, where the first tank portion and the second portion together define the tank.

The machine 40 is provided with RF cable connections. A first connection 44 connects the upper part 41 to ground for electrical earthing, so that the upper part 41 can act as a cathode. A second connection 45 connects the lower part 42 and spindle 48 to an RF generator (not shown in these Figures) such as that shown in FIG. 1 so that the spindle 48 can act as an anode. A metallic top cover 46 and a metallic bottom cover 47 are arranged around the base of the tank to surround the connections 44,45 to provide electromagnetic shielding.

In operation, textiles to be dried, such as yarn packages P, are housed onto the spindle 48 and hence contained within the tank. The RF generator is operated to apply the RF wave power to the spindle 48, so that an RF wave emits from the spindle 48, through the yarn packages P to discharge to the upper part 41 or wall of the tank. The yarn packages P are thus situated in an oscillating electric field extending between the spindle 48 and the tank wall so that water molecules in the yarn are caused to vibrate at the RF frequency (preferably 27.12 MHz). This produces heating, or an increase of internal kinetic energy, causing the water molecules to escape from the yarn by evaporation. The yarn packages P are thereby dried.

Use of the spindle and tank as a RF anode and cathode gives uniform drying of textiles with a reduced or eliminated need to precisely adjust the anode-cathode separation during operation, compared to conventional electron tube RF textile driers.

The water vapour is removed from the machine 40 by way of an outlet 49 fitted at the top of the tank, using a fan or blower to extract air from the interior of the machine 40. An inlet 50 is provided at the base of the tank so that fresh air can be pumped into the machine 40 to replace the water-laden air removed from the outlet 49. The outlet 49 may be provided with one or more air filters (not shown) to prevent contaminants or foreign bodies from entering the tank.

A moisture content monitoring system (not shown) may be provided to monitor and govern the water evaporation (drying) rate to prevent over-drying of the textiles, since this may damage the textiles. The moisture content may be monitored by any suitable method, such as measuring the concentration of water in the air extracted from the tank outlet, or by weighing the textiles during the drying process. The monitoring system can be linked to the RF generator to switch off the electric field when the desired level of textile dryness is reached.

The design of the machine as shown in FIGS. 4 and 5 provides good RF shielding and hence reduced electromagnetic interference. The tank is a closed vessel and connected to ground, so no RF waves leak out to the surrounding environment during operation. This is aided by the shielding of the RF connectors 44, 45 by the metallic covers 46, 47. Additionally, the driver unit and power amplifier units of the generator are preferably housed in metallic shells or casing to provide further shielding and endure a safe and radiation-free working environment.

Although using the tank wall as the cathode provides the above advantage in terms of shielding, the invention may alternatively be implemented by connecting the tank wall to the RF generator as the anode and earthing the spindle to act as the cathode. In such an arrangement, it would be necessary to provide additional shielding around the machine as a whole if it was desired to avoid RF leakage to the surroundings.

In a further embodiment, a drying machine according to the invention may also be used for textile dyeing, to provide an integrated dyeing-drying machine. This is made possible by the proposed design of the machine, comprising a textile-holding spindle inside a tank. Such an arrangement is already used for textile dyeing. Textiles such as yarn packages are mounted on a spindle positioned within a pressure tank, and dye liquor is circulated through the tank to dye the textiles to a desired colour and shade. Considering a machine constructed as that in FIGS. 4 and 5, the dye liquor can be introduced into the tank by injecting it up inside the spindle. Openings in the spindle allow the liquor to pass out and into the textiles where it is absorbed. Remaining liquor passes into the body of the tank, and is removed from the tank, possibly for recirculation within the same machine or to be circulated to a different machine. Referring to FIG. 5, the pipes 50 and 51 can be used to add and remove the dye liquor if they are connected to a dye liquor reservoir via a pipe network including valves and pumps. Once the dyeing process is complete and all dye liquor drained from the tank, the drying process can be activated by operating the RF generator and the air circulation system. For this purpose, the inlet pipe 50 can be provided with a valve operable to connect the pipe to either the dye liquor pipe network or to an air pump to introduce fresh air to the tank as described above. In this way, both dyeing and drying can be accomplished sequentially in the same machine. This removes the need to have separate machines for the two processes, and also eliminates the time-consuming transportation of textiles from a dyeing machine to a drying machine.

An example of a textile dyeing machine and system in which dye liquor is circulated around tanks for holding textiles is given in GB 2,404,199.

Since the present invention proposes that a RF drying machine can be implemented using the design of a conventional dyeing machine, existing dyeing machines can be readily adapted to provide integrated dyeing and drying simply by connecting an RF generator to the relevant parts of a dyeing machine. An air circulation system should also be provided to extract the evaporated water. Although a solid-state RF generator is preferred since it offers many advantages, the same drying effect can be achieved using an electron tube generator if preferred.

The invention is not limited to the design of machine illustrated in FIGS. 4 and 5. Other configurations of machine may also be used, having alternative tank and spindle shapes and positions. The machine maybe configured to provide both dyeing and drying, or drying alone, and in either case, solid-state or electron tube RF generation may be used. Similarly, the embodiments of the RF generator shown in FIGS. 1-3 are exemplary only, other designs of solid-state RF generator will be readily apparent to the skilled person and may be used instead. Also, the machine may be intended for the processing of various forms and types of textiles; the invention is not limited to the yarn packages shown in FIGS. 4 and 5.

1. An apparatus for drying textiles comprising:
a tank for receiving textiles, the tank defined by a first tank portion and second tank portion that are electrically insulated from one another; and
a radio frequency power generator connected to the tank so as to be operable to generate an oscillating electric field at a radio frequency between the first tank portion and the second tank portion, to produce heating and evaporation of water molecules in the textiles.

2. The apparatus according to claim 1, in which the first tank portion comprises a wall of the tank, and the second tank portion comprises a spindle positioned within the tank for supporting textiles received in the tank.

3. The apparatus according to claim 2, in which the radio frequency power generator is connected to the spindle such that the spindle acts as an anode for the purpose of generating the electric field.

4. The apparatus according to claim 3, in which the wall is connected to an electrical ground.

5. The apparatus according to claim 1, in which the radio frequency power generator is a solid-state radio frequency power generator.

6. The apparatus according to claim 1, in which the radio frequency power generator comprises a driver unit operable to generate a radio frequency signal and one or more amplifier units operable to receive the radio frequency signal from the driver unit and amplify the radio frequency signal.

7. The apparatus according to claim 6, in which the radio frequency power generator further comprises a divider unit operable to receive the radio frequency signal from the driver unit and distribute it between at least two amplifier units arranged in parallel, and a combiner unit operable to receive and combine the amplified radio frequency signals from the amplifier units.

8. The apparatus according to claim 6, in which one or more of the driver unit and the amplifier units are provided with built-in test devices operable to monitor operation of the units.

9. The apparatus according to claim 1, in which the tank is provided with an outlet for extraction of evaporated water molecules.

10. The apparatus according to claim 9, in which the tank is further provided with an inlet for introduction of air into the tank.

11. The apparatus according to claim 1, in which the apparatus is further configured for dyeing of textiles received in the tank.

12. The apparatus according to claim 11, in which the tank is provided with a dye liquor inlet and a dye liquor outlet by which dye liquor may be circulated through the tank to dye textiles received in the tank.

13. The apparatus according to claim 1, in which the textiles comprise one or more yarn packages.

14. A method of drying textiles, comprising:
arranging textiles within a tank defined by a first tank portion and a second tank portion electrically insulated from the first tank portion; and
generating an oscillating electric field at a radio frequency between the first tank portion and the second portion to heat and evaporate water molecules in the textiles.

15. The method according to claim 14, in which the first tank portion comprises a wall of the tank, and the second tank portion comprises a spindle positioned within the tank for supporting textiles arranged in the tank.

16. The method according to claim 15, in which the spindle is used as an anode for the purpose of generating the electric field.

17. The method according to claim 16, in which the wall is connected to an electrical ground.

18. The method according to claim 14, further comprising operating a solid-state radio frequency power generator connected to the tank to generate the oscillating electric field.

19. The method according to claim 18, in which the solid-state radio frequency power generator comprises a driver unit operable to generate a radio frequency signal and one or more amplifier units operable to receive the radio frequency signal from the driver unit and amplify the radio frequency signal.

20. The method according to claim 19, in which the solid-state radio frequency power generator further comprises a divider unit operable to receive the radio frequency signal from the driver unit and distribute it between at least two amplifier units arranged in parallel, and a combiner unit operable to receive and combine the amplified radio frequency signals from the amplifier units.

21. The method according to claim 19, in which one or more of the driver unit and the amplifier units are provided with built-in test devices operable to monitor operation of the units.

22. The method according to claim 14, further comprising extracting the evaporated water molecules from the tank.

23. The method according to claim 22, further comprising introducing air into the tank during extraction of the evaporated water molecules.

24. The method according to claim 14, further comprising, between arranging the textiles in the tank and generating the oscillating electric field:
adding dye liquor to the tank to dye the textiles; and
removing unused dye liquor once the textiles are dyed.

25. The method according to claim 14, in which the textiles comprise one or more yarn packages.
